(19) United States
(12) Patent Application Publication
(10) Pub. No.: US 2013/0171927 A1
(43) Pub. Date: Jul. 4, 2013

(54) VERBALLY PROMPTING INDICATOR DEVICE USING VERBAL HUMANLIKE VOICES IN CONNECTION WITH SCUBA TANKS, DIVE COMPUTERS AND OTHER DIVE EQUIPMENT FOR IMPROVED UNDERWATER DIVING PERFORMANCE

(71) Applicants: TERRY KEITH BRYANT, SINGER ISLAND, FL (US); TIMOTHY STUART BOBERG, PALM BEACH, FL (US)

(72) Inventors: TERRY KEITH BRYANT, SINGER ISLAND, FL (US); TIMOTHY STUART BOBERG, PALM BEACH, FL (US)

(21) Appl. No.: 13/769,299

(22) Filed: Feb. 16, 2013

Related U.S. Application Data
(63) Continuation-in-part of application No. 12/504,992, filed on Jul. 17, 2009, now Pat. No. 8,378,793.
(60) Provisional application No. 61/081,922, filed on Jul. 18, 2008.

(51) Int. Cl. H04B 13/02

(52) U.S. Cl. CPC H04B 13/02
USPC 455/40

(57) ABSTRACT

Improvements to existing diving tanks and dive computers are achieved through the use of an electronic device which employs audible, verbal, simulated, humanlike words or phrases to inform a user while underwater of dive information, including, but not limited to, gas volumes present in the tank, ascent rates, water temperature, depth levels, remaining time in the water, etc. In one embodiment a microcontroller can be used to facilitate the different settings and information that the talking tank or dive computer supplies. The electronic assembly of the present invention can be in communication with the existing pressure gauges, sensors, and valves associated with the talking tank or dive computer.

This application is a continuation-in-part of U.S. application Ser. No. 12/504,992, filed Jul. 17, 2009, which claims the benefit of and priority to U.S. Application Ser. No. 61/081,922, filed Jul. 18, 2008, all above-identified applications are incorporated hereto by reference in their entirety.

### FIELD OF THE INVENTION

The present invention relates to improving conventional SCUBA (self-contained underwater breathing apparatus) and diving equipment, such as but not limited to SCUBA tanks, dive computers and components necessary for proper diving procedures and other dive equipment used in underwater diving activities. In conjunction with a demand regulator, the SCUBA tank dispenses oxygen, nitrox, air, pure oxygen, trimix, heliox or other helium-based gas or any other gas or combination of gases used for underwater diving activities (collectively referred to herein as “gas” or “breathing gas”) under high, pressure to a diver while underwater, in which the gas contained within the tank is dispensed to the underwater diver (also referred to as “user” herein), in relationship to his or her underwater breathing needs.

### BACKGROUND OF THE INVENTION

Dive computers are used by divers for determining the time and depth of a dive to permit a proper ascent rate to be calculated and displayed on the computer display or screen, such as but not limited to, a LCD screen. The displayed information helps to prevent the diver from experiencing physical complications from ascending too quickly or for remaining underwater too long. Some of the typical kinds of information displayed on the LCD screen can include (1) current depth, (2) maximum depth reached on the current dive, (3) the time remaining at the current depth without the need for decompression stops on ascent; (4) dive time (5) required decompression stop depth and time, (6) water temperature, and (7) ascent rate.

Certain dive computers are designed to display information from a diving cylinder pressure sensor, such as gas pressure and estimated remaining time based on available gas and rate of gas consumption. Additionally, certain dive computers have warning buzzers that warn the diver of events such as (1) excessive ascent rates, (2) missed decompression stops, (3) maximum operation depth exceeded, and (4) oxygen toxicity limits exceeded. However, this requires the diver to remember what each buzzer sound represents.

### SUMMARY OF THE INVENTION

The present invention improves upon existing diving tanks and dive computers and components necessary for proper diving procedures through the utilization of an electronic enhancement device which employs audible, verbal, simulated, generated, synthesized, or any similar process to provide vocalization of a humanlike voice, word, words, or phrases to inform the user of dive information, including, but not limited to, the exact volumes, rations, or whatever amount of gas or status thereof that is present in the tank gas container, ascent rates, water temperature, depth levels, inform a diver of his or her actual descent at a certain distance (i.e. every ten feet, etc.), inform a diver when he or she reaches a planned dive depth, inform a diver of his or her remaining down time at a specific depth, inform a diver of his or her remaining down time in certain time intervals based on the diver's current usage rate, inform the diver when it time to go up to ensure adequate time for planned safety stops, remind a diver not to hold his or her breath on ascent, inform the diver if his or her ascent rate is too fast, inform the diver when to stop for various decompression points and when to continue ascent, etc., to ensure safety per established or recommended guidelines.

The electronic device can also verbally indicate to the diver whether the tank is almost empty, completely full, or provide audible, verbal indication of percentage or other remaining levels of volume in which said gas is contained within the cylinder. The electronic device can also verbally indicate when the reserve level in the tank has been reached, to alert the diver to terminate the dive to ensure that a sufficient amount of gas remains in the tank for the diver to safely reach the water surface. Other underwater readings and measurements can also be verbally indicated by the present invention including but not limited to, depth level, rate of ascent, rate of descent, etc., as well as those readings and measurements mentioned above. The information verbally provided by the present invention can be also used to confirm the accuracy of the same information being visually indicated by the user's dive computer.

Thus, the main purpose of the present invention is to provide audible, verbal, status of the volumes and amount of gas remaining in the tank, ascent and depth information, as well as to provide other relevant information related to an underwater activity. In order to provide the talking tank, talking dive computer or other talking dive equipment with the appropriate functions, in a preferred embodiment, a microcontroller, but not limited to, can be used to facilitate the different settings and information that the talking tank, talking dive computer, etc. can supply in conjunction with the adequate components to provide an audible, verbal, simulated, generated, synthesized, etc. responses and that can provide humanlike, words, or phrases, or a single word, of the relevant dive related information, as herein mentioned. Thus, the talking tank, talking dive computer, etc. can provide an immediate verbal indication to the user of gas volumes, depth levels, ascent rates, descent rates, reserve levels, etc. through the sound of an audible, verbal, humanlike, simulated generated, synthesized, or any similar process, as well as serving to confirm information provided by a dive computer worn by the user.

The electronic assembly of the present invention can be in communication with the existing pressure gauges, sensors, indicators and/or valves associated with the tank, dive computer, etc. Furthermore, additional gauges, sensors, indicators, valves, etc. can also be provided in order obtain the various readings which can be provided by the present invention talking tank, talking dive computer, talking dive equipment, etc.

Thus, with the conception of the talking tank, talking dive computer and other talking dive equipment, a significant advancement in underwater diving has been made, as diver safety, while underwater has been enhanced through the utilization of the present invention employing audible, verbal, human-like voices to inform the user of the gas status in his or her tank, while also verbally providing other valuable diving information to the user during the underwater activity.

Accordingly, it is the intention of the present invention through audible/verbal means to increase the safety of the dive, while at the same increasing the enjoyment of the user's underwater diving experience.

All components of the present invention can either be housed in waterproof housings or will be tolerable to being in contact with fresh and/or salt water and increases and decreases in underwater pressure due to depth changes.

### BRIEF DESCRIPTION OF THE DRAWINGS

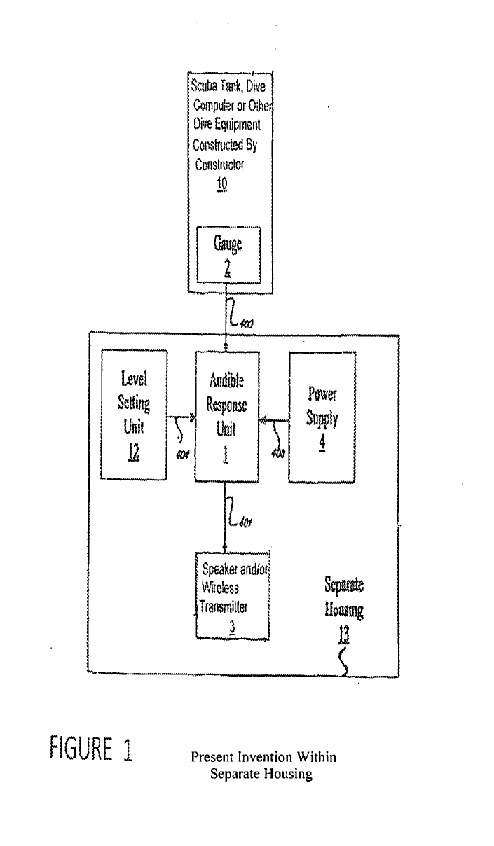

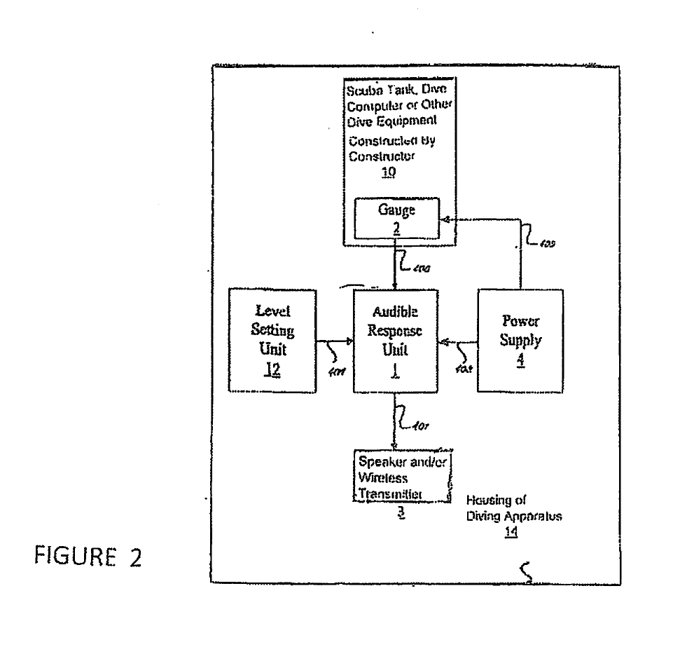

General block diagram illustrations for one embodiment of the present invention, which are not considered limiting in any way, are shown in FIGS. 1 and 2.

### DETAILED DESCRIPTION OF THE INVENTION

The present invention improves upon existing diving tanks, SCUBA tanks, oxygen tanks and diving cylinders (collectively referred to as “tank” or “tanks” herein) and dive computers and components necessary for proper diving procedures through the utilization of an electronic enhancement device which employs audible, verbal, simulated, generated, synthesized, or any similar process to provide vocalization of a humanlike voice, word, words, or phrases to inform the user of dive information, including, but not limited to, the exact volumes, rations, or whatever amount of gas or status thereof that is present in the tank gas container, ascent rates, water temperature, depth levels, inform a diver of his or her actual descent at a certain distance (i.e. every ten feet, etc.), inform a diver when he or she reaches a planned dive depth, inform a diver of his or her remaining down time at a specific depth, inform a diver of his or her remaining down time in certain time intervals based on the diver's current usage rate, inform the diver when it time to go up to ensure adequate time for planned safety stops, remind a diver not to hold his or her breath on ascent, inform the diver if his or her ascent rate is too fast, inform the diver when to stop for various decompression points and when to continue ascent, etc., to ensure safety per established or recommended guidelines.

The electronic device can also verbally indicate to the diver whether the tank is almost empty, completely full, or provide audible, verbal indication of percentage of volume in which said gas is contained. This function can also alternatively or additionally be adjusted or provided by manual pressing or selection of a button or similar responsive unit by the diver to perform automatically or manual adjustments. The electronic device can also verbally indicate when the reserve level in the tank has been reached, to alert the diver to terminate the dive to ensure that a sufficient amount of gas remains in the tank for the diver to safely reach the water surface. Other underwater readings and measurements can also be verbally indicated by the present invention including but not limited to, depth level, rate of ascent, rate of descent, etc., as well as those readings and measurements mentioned above. The information verbally provided by the present invention can be also used to confirm the accuracy of the same information being visually indicated by the user's dive computer.

To achieve the novel functions provided by the present invention, as described herein, are accomplished through novel technology which can comprise of a novel combination of existing electronic components such as but not limited to: microchips, microcontrollers, integrated circuit controllers, coin cells, power sources, batteries (rechargeable or non-rechargeable), electronic circuitry, wireless circuitry, wireless transmitters and receivers, multiplex circuits, electrodes, mylar speakers, speakers, sound modules, inductors, electro chromium, PC boards, inductive sensory systems, electrolyte layers, voltage regulators, oscillators, hardware, software, firmware, indicators, etc. The electronic components will be housed in a waterproof housing which can either be separate from the tank but in communication with the internal area of the tank or provided as part of the tank during the manufacturing process, including, but not limited to, where the tank serves as the housing for the components. In order to produce an audible, verbal humanlike voice as herein described the electronic device can also include an audio response unit, which can include an audio storage unit, audio amplifier, etc. Alternatively, the electronic assembly for verbal indication can be housed within the dive computer and be in communication with the electronics, circuitry, algorithms, etc. that generate the information visually provided by the dive computer. A speaker can be provided for verbally providing the information usually visually displayed on a dive computer such as a LCD display or similar unit which will provided through the present invention provide an audible verbal indication in synthesis with the dive computer directly or through being transmitted to the headsets, ear phones, etc. worn by the user.

Though certain components or combination of components needed for achieving the novel functions of the present invention may be described generally herein, it should be understood that the invention is not limited to any specific technology. Accordingly, any new, current, past, and/or future technology, and all combinations thereof, which can achieve the unique functions of the present invention discussed herein can be used and all are considered within the scope of the invention. Thus, the invention covers all past, current and future technology that will produce and provide audible, verbal, simulated, generated, or prerecorded humanlike voices of phrases, verbal commands, responses, or informative information to a user while underwater.

When used in connection with the tank, the present invention also encompasses providing audible beeps, tones, artificial sounds or noises (collectively referred to “non-verbal sounds”) to the diver which can represent different levels of remaining gas volume contained within the tank. Non-verbal sounds could also be generated and provided to the user to represent different depth levels, as well as to notify the user if he or she is descending or ascending too rapidly. Preferably, the non-verbal sounds features are provided in addition to the humanlike voice information discussed above though not required. However, it is also within the scope of the invention to provide these features as an alternative to providing audible humanlike voice information to the underwater user as needed or deemed necessary.

The word humanlike encompasses the use of audible, verbal words, or phrases or a single word that may sound different in a variety of tones, such as a talking or speaking human or fictional animal, simulated or generated voices, or similar voice animation's to produce a humanlike sound, as described herein. The variation of humanlike sounds can include many different characteristics of audible, verbal, simulated, generated, or synthesized words or a single word and all are considered to consist of sounding like human words. The present invention is not limited to any specific language and can be provided in more than one language, with the user selecting his or her language of choice.

The talking tank in synthesis with a dive computer, the diver worn dive computer, or other dive equipment, includes the parts needed for the tank, dive computer, etc. along with any or all parts of whatever equipment or components needed to provide the audible verbal, response information and messages. As non-limiting examples, the present invention electronics can include voice chips or modules or any similar device, which can produce, generate, or synthesize a humanlike voice, as aforementioned. The present invention can provide word, words and/or phrases as applicable and can audible, verbal responses, commands, instructions, and/or information to the user to enhance the user's diving experience.

Thus, the main purpose of the present invention is to provide audible, verbal, status of the volumes and amount of gas remaining in the tank, ascent and depth information, as well as to provide other relevant information related to an underwater activity. In order to provide the talking tank, dive computer or other dive equipment with the appropriate functions, in a preferred embodiment, a microcontroller, but not limited to, can be used to facilitate the different settings and information that the talking tank, dive computer, etc. can supply in conjunction with the adequate components to provide an audible, verbal, simulated, generated, synthesized, etc. responses and that can provide humanlike, words, or phrases, or a single word, of the relevant dive related information, as herein mentioned. Thus, the talking tank, talking dive computer, etc. can provide an immediate verbal, indication to the user of gas volumes, depth levels, ascent rates, descent rates, reserve levels, etc., as well as serving to confirm information provided by a diver computer worn by the user through the sound of an audible, verbal, humanlike, simulated generated, synthesized, or any similar process.

In one embodiment, the produced voice or voices can originate directly from the talking tank or talking dive computer and can be sufficiently loud enough such that voices can be heard underwater by the user through a speaker in communication with the electronic assembly. Alternatively, a transmitter can be provided, as part of the electronic assembly for transmitting the verbal, audible information and/or non-verbal sounds wireless to a headphones, headset, speaker, earphones, etc. (capable of being used underwater) worn by the user. Additionally, given the typical close proximity of the tank(s) to the user's ears, wired headphones, headsets, speakers, ear phones, etc. (capable of being used underwater) can also be used, with the wire or cord running from the electronic assembly associated with the tank to the headphones, headsets, speakers, earphones, etc. The wired or wireless versions can be covered and protected by the diver's wet suit/dry suit (“suit”) or can be incorporated into the suit. It is also within the scope of the invention to use whatever form of deliverance of sound that is preferable and sufficient to create the best quality and though including, is not limited to direct earphones or water responsive sound production.

The present invention can verbally provide exact measurements and verbally inform the user as to the status of contained gas and other relevant dive information according to the aforementioned programmable functions. Where the invention informs the user that the gas reserve level has been reached and determines that the user is not ascending, the invention can be programmed to continuously send warning messages to the user to return to the water surface before the gas within the tank is completely consumed.

The electronic assembly of the present invention can be in communication with the existing pressure gauges, sensors, and valves associated with the tank, dive computer, etc. Furthermore, additional gauges, sensors, valves, etc. can also be provided in order obtain the various readings which can be provided by the present invention tank. The various gas levels for providing information to the user can be set by the manufacturer or user of the talking tank, dive computer or can be adjustable by the user accordingly. The invention is not limited to any specific settings pre or post sale. Whether constructing the tank with additional gauges, valves, sensors and/or placing the electronic assembly in communication existing gauges, valves, etc., the talking tank, dive computer, etc. provides a novel approach for audibly/verbally informing the diver of various dive related information, as well as providing a way to confirm the accuracy of readings being displayed by the diver's dive computer. In the event a blind person wishes to experience the feelings of being underwater (preferably with a guide person), the benefits of the present invention audibly/verbally providing the dive information becomes even more beneficial.

The audible, verbal responses and information produced by the present invention can be through the use of a simulated, generated, synthesized, prerecorded human voice, or anything similar, as herein mentioned, in order to facilitate function, as herein described (male or female). An air pressure sensor, gauge, or similar device, can be installed at the appropriate location on the talking tank to detect and measure the exact amount of volumes and process and relay those accurate readings in order to supply audible, verbal verification of said readings as mentioned herein, which can correspond to the visual measurements shown on the gauge or dive computer. Depth sensors can also be similarly employed. The sensor(s), which will be in communication with circuitry and components necessary for operation, will be placed where needed with respect to the talking tank in order to achieve the goals of the present invention. The sensor(s) employed for measuring the amount of gas left in the tank can be connected directly to the area located at the source of where the gas is being dispersed.

In lieu of an air pressure sensor, the talking tank can also be provided with electronic sensors, which can attached directly in communication with the existing gauges (i.e. pressure gauges, etc.) at each numeric point or the pressure gauge hose. The present invention is not considered limited to any number or type of sensors, indicators, and/or gauges and is also not considered limited to any specific location for the sensors, indicators and/or gauges.

As mentioned above, a speaker can be attached to whatever specifications or structure of the waterproof housing, on the aforementioned dive equipments, as needed in order to produce the required audible, verbal sound, as herein specified. Alternatively, the above noted wired or wireless headsets, headphones, speakers, etc. can be used. The talking tank and/or dive computer can have as many audible, verbal commands and responses as needed or required, supplying an audible, verbal, humanlike voice as herein described, according to the output potential employed and/or programmed. The various levels and readings are not considered limited to any percentages or any specific phrases, and all variations and combinations can be used and all are considered within the scope of the invention.

Another feature of the present invention is the ability to include a programmable timer for informing the user on the amount of time he or she has been participating in the underwater activity and/or to verbally let the user know that a certain period of time has elapsed and it is now time to return to the water surface. This feature is considered an additional feature which can be used with present invention but not necessarily mandatory to achieve the broad novel functions of the present invention. Thus, when the set time period has elapsed, the present invention will automatically vocalize such event to the user. This added safety feature will help assure that the user begins his or her return with enough gas remaining in the tank to reach the water surface. The talking tank and/or dive computer can be programmed to continue to inform the user periodically regarding the remaining amount of gas contained within the tank. Again, such updates can be provided through audible, verbal, humanlike voices, as described herein, using a word, words or phrase to accomplish this goal. The updates can be programmed to be based on amount of elapsed time or based on an amount of gas loss from within the tank.

A power source can be employed to operate the necessary components to facilitate the concept of the talking tank. Preferably, the power source can be rechargeable or non-rechargeable batteries. However, other power sources that can be used underwater, now known or later developed can also be used with the present invention and are considered within the scope of the invention.

Thus, with the conception of the present invention talking tank, talking dive computer and other talking dive equipment, a significant advancement in underwater diving has been made, as diver safety, while underwater has been enhanced through the utilization of the present invention employing audible, verbal, human-like voices to inform the user of the gas status in his or her tank, while also verbally providing other valuable diving information to the user during the underwater activity. With the present invention, a diver, who may be focusing his or her attention on other underwater matters, can be automatically verbally alerted of the gas level within the tank and/or other dive information, without having to visually inspect gauges or a dive computer, through the employment of informative words and phrases produced by the talking tank or dive computer itself.

The present invention provides the ability to replace or expand on previously visually provided information with audible, verbal, humanlike word, words or phrase, in order to prompt, command, instruct, inform, measure, guide or warn the user of his or her particular situation. With the present invention, information previously read and provided by a computer or microcontroller visually to the user, can now be provided audibly and verbally. The information can still be provided visually as well. With use of the present invention, the diver's underwater experience is not distracted with equipment readings, as the information is provided audibly/verbally to the diver, so that he or she can continue to concentrate on the underwater activity (i.e. viewing sea life, underwater plants and reefs, exploring sunken ships, etc.). Additionally, while focusing on the underwater activity, the user may also forget to visually check the equipment readings, which could lead to a dangerous underwater situation for the user. The present invention overcomes this problem, as the information is automatically provided to the user audibly/verbally without requiring the user to discontinue his or her current underwater activity. Thus, the present invention permits to user to freely dive, without having to worry about having to take the many inconvenient readings, which will be achieved automatically by the present invention. It is also within the scope of the invention to provide pre-water entry instructions audibly/verbally through the present invention before the user enters the water.

When used in conjunction with a dive computer, the present invention provides a voice prompting and indicating SCUBA dive computer, which takes information that is normally only visually available to the diver, and also or alternatively provides such information audibly to the diver. Thus, the diver can also be prompted to perform everything that he or she is taught to do, but may not perform during the dive. The dive computer can be also be programmed to provide other dive related information or other information not usually provided with conventional dive computers, that can then be verbally provided to the user.

For example, the dive computer could be provided with technology and programmed to send and receive text messages. For incoming messages, the content of the message could be read to the dive through use of the present invention audible/verbal capabilities.

Accordingly, it is the intention of the present invention through audible/verbal means to increase the safety of the dive, while at the same increasing the enjoyment of the user's underwater diving experience.

In one embodiment of the present invention, the verbally prompting device of the present invention can work in conjunction with an “air integrated” dive computer. In this embodiment, audible information from the dive computer can be transmitted to water proof ear buds, either wirelessly, or through hard wiring. The receiver and ear buds can be designed to attach to the diver's mask, such as, at the mask strap. The transmitter can be connected to the dive computer attached to the air hose of the scuba tank.

In all embodiments, information that can be transmitted can include, but is not limited to, the following (i) dive depths at predetermined frequency levels for descent (10 feet, 20 feet, etc.), (ii) percent of air remaining for a no decompression, dive (50%, 40%, etc.), (iii) minutes of downtime remaining at current depth and usage, (iv) ascend now for no decompression dive (repeat every 15 seconds until ascending—though such time period not considered limiting), (v) ascent rate alarm (pre-programmable), (vi) ascend depth at ten foot intervals (though such distance not considered limiting) until safety stop depth, (vii) alert to planned safety stop depth (pre-programmable), and (viii) countdown for safety stop.

Another feature that can be provided with talking tank, talking dive computer, talking dive equipment, etc. is a Global Positioning System (“GPS”) module. With a GPS capable talking tank, talking dive computer, talking dive equipment, etc. the verbally prompting component of the invention can be designed and/or programmed to provide the user/diver with audible distance and directional information to “go to” and “return to” points. The “go to” and “return to” points can be pre-programmed by longitude and latitude, memory marked or by other technology. Course directions could be audibly given to the diver/user, such as, but not limited to, using the 12 hours of a clock (veer to right 2 o'clock, for 50 yards). Other forms of directions can be used and also are considered within the scope of the invention. The GPS, diver/user location and other alarm information could be transmitted to the dive boat, for visual display and/or audible transmission, such that the individual(s) on the dive boat can be updated with the underwater situation of the diver/user.

The present invention can also be designed such that the under GPS location of a diver can also be provided to the talking tank, talking dive computer, talking dive equipment, etc. of the diver's dive buddy and vice versa. Therefore, in the event that the divers are no longer in visual communication with each other, the present invention can provide the details of the divers' locations. Audible verbal information or audible sounds can be used to guide one diver towards the location of the other diver. As a non-limiting example, as one diver swims to towards the location of the other diver, the present invention will verbally guide and instruct the diver to make sure he or she continues in the correct direction. The usefulness of this feature is further enhanced, where the other diver has moved from the location the tracking diver is trying to reach. Where audible sounds are provided, one type of sound can indicated to keep going in the same direction, while another sound can represent that the diver needs to adjust his or her course of direction. Additionally, all information verbally transmitted to the diver can also be transmitted to the diver's dive buddy. Alternatively, only where there is a problem with the diver, will the diver's information be sent to the diver's dive buddy. Furthermore, so as not to confuse the dive buddy with information for the diver, with information relating to the dive buddy, each voice can be unique, similar to how each human voice is considered to be unique.

It is also contemplated that as an additional feature of the present invention, a “visual” onboard screen can be provided on the boat for use by the individual(s) on the boat. The onboard screen and associated components/electronics can also have audible/verbal capabilities such that the individual(s) on the boat can also be informed (visually and/or audibly) of any information being provided to the diver below, such as, but not limited to, warnings, alerts, diver vitals, diver location, etc.

In one embodiment using GPS technology, the talking tank, dive computer, dive equipment, etc is provided with GPS technology, and is in electronic communication with the dive boat through the GPS or other wireless technology. Through this electronic communication, a verbal coordinator can be established, which provides information to the dive boat occupant(s) as to the diver location, diver vitals, diver equipment issues, etc. Through receipt of this information verbally, the boat occupant(s) can be made aware of any existing problems with the diver, prior to the diver's ascent and without anyone having to watch a screen or interface. Thus, the occupant(s) can attend or begin to attend to the problem or prepare for attending to the problem while the diver is still underwater.

All components of the present invention can either be housed in waterproof housings or will be tolerable to being in contact with fresh and/or salt water. Furthermore, being capable of being operable underwater will also require that the components selected for the present invention should also be able to operate under changing water pressure conditions in view of the ascent or descent of the diver.

Additionally, the present invention can be provided with a “check button” for manually checking proper operation of the one or more components of the present invention at any time.

In addition to the technology described and/or shown in the drawings for generating audible verbal information, other now known or later developed audible voice generating technology can be used and is considered within the scope of the invention.

Furthermore, all wireless and wired communication technology now known or later developed that can be used where the sender and/or the recipient are located underwater can be used and is considered within the scope of the invention.

General block diagram illustrations for one embodiment of the present invention, which are not considered limiting in any way, are shown in FIGS. 1 and 2.

All locations, sizes, shapes, proportions, measurements, amounts, angles, component locations, part locations, fasteners, configurations, weights, dimensions, values, percentages, ranges, materials and/or orientations discussed above or shown in the drawings are merely by way of example and are not considered limiting and other locations, sizes, shapes, proportions, measurements, amounts, angles, component locations, part locations, fasteners, configurations, weights, dimensions, values, percentages, ranges, materials and/or orientations can be chosen and used and all are considered within the scope of the invention.

Dimensions of certain parts as shown in the drawings may have been modified and/or exaggerated for the purpose of clarity of illustration and are not considered limiting.

Unless feature(s), part(s), component(s), characteristic(s) or function(s) described in the specification or shown in the drawings for a claim element, claim step or claim term specifically appear in the claim with the claim element, claim step or claim term, then the inventor does not considered such feature(s), part(s), component(s), characteristic(s) or function(s) to be included for the claim element, claim step or claim term in the claim for examination purposes and when and if the claim element, claim step or claim term is interpreted or construed. Similarly, with respect to any “means for” elements in the claims, the inventor considers such language to require only the minimal amount of features, components, steps, or parts from the specification to achieve the function of the “means for” language and not all of the features, components, steps or parts describe in the specification that are related to the function of the “means for” language.

While the invention has been described and disclosed in certain terms and has disclosed certain embodiments or modifications, persons skilled in the art who have acquainted themselves with the invention, will appreciate that it is not necessarily limited by such terms, nor to the specific embodiments and modifications disclosed herein. Thus, a wide variety of alternatives, suggested by the teachings herein, can be practiced without departing from the spirit of the invention, and rights to such alternatives are particularly reserved and considered within the scope of the invention.

What is claimed is:

1. An underwater electronic communication device comprising:
a dive computer providing dive information;
ear buds adapted to be heard by a diver;
a transmitter in electronic communication with the dive computer; and
a receiver in communication with said ear buds and in wireless communication with said transmitter.

2. The underwater electronic communication device of claim 1 wherein said dive computer calculating or receiving dive information relevant to the diver and having electronic technology to permit it to provide the dive information in a audible verbal format.

3. The underwater electronic communication device of claim 2 wherein the dive information includes one or more of the following: (i) dive depths (ii) percent of air remaining, (iii) minutes of downtime remaining, (iv) ascend now alert, (v) ascent rate alarm (vi) ascend depth at a predetermined interval until safety stop depth is reached, (vii) alert to planned safety stop depth, and (viii) countdown for safety stop.

4. The underwater electronic communication device of claim 1 wherein said receiver is adapted for securement to a dive mask worn by the diver.

5. The underwater electronic communication device of claim 1 wherein said ear buds are adapted for securement to a dive mask worn by a diver.

6. The underwater electronic communication device of claim 1 wherein said transmitter is secured to the dive computer.

7. The underwater electronic communication device of claim 6 wherein said dive computer is adapted for attachment to an air hose associated with a scuba tank worn by the diver.

8. The underwater electronic communication device of claim 2 wherein the dive information in audible verbal format is transmitted from the transmitter to the receiver and heard by the diver through the ear buds.

9. The underwater electronic communication device of claim 1 wherein the ear buds are water proof and are in wireless electronic communication with the receiver.

10. The underwater electronic communication device of claim 1 wherein the ear buds are water proof and are in wired electronic communication with the receiver.

11. The underwater electronic communication device of claim 1 further comprising GPS technology incorporated within or in electronic communication with the dive computer, said GPS technology provides a current underwater location of the diver.

12. The underwater electronic communication device of claim 1 further comprising a second receiver and a speaker located on a boat, wherein said second receiver receives dive information from the dive computer sent by the transmitter which is produced and heard through the speaker, wherein one or more occupants on the boat are informed of the dive information for the diver and can be alerted to any existing problem being experienced by the diver.

13. The underwater electronic communication device of claim 11 further comprising a second receiver and a speaker located on a boat, wherein said second receiver receives dive information from the dive computer sent by the transmitter which is produced and heard through the speaker, wherein one or more occupants on the boat are informed of the dive information for the diver and the diver's current underwater location and can be alerted to any existing problem being experienced by the diver.

14. The underwater electronic communication device of claim 11 wherein information concerning the current underwater location of the diver or an existing problem being experienced by the diver can be sent to a dive buddy for the diver and received by a receiver worn or associated with the dive buddy.

15. An underwater electronic communication device comprising:
a dive computer providing dive information, said dive computer adapted for attachment to an air hose associated with a scuba tank worn by the diver;
water proof ear buds adapted to be heard by a diver;
a transmitter in electronic communication with and secured to the dive computer; and
a receiver in communication with said ear buds and in wireless communication with said transmitter, said receiver adapted for securement to a dive mask worn by the diver;
wherein said dive computer calculating or receiving dive information relevant to the diver and having electronic technology to permit it to provide the dive information in a audible verbal format;
wherein the dive information in audible verbal format is transmitted from the transmitter to the receiver and heard by the diver through the ear buds.

16. The underwater electronic communication device of claim 15 wherein the dive information includes one or more of the following: (i) dive depths (ii) percent of air remaining, (iii) minutes of downtime remaining, (iv) ascend now alert, (v) ascent rate alarm (vi) ascend depth at a predetermined interval until safety stop depth is reached, (vii) alert to planned safety stop depth, and (viii) countdown for safety stop.

17. The underwater electronic communication device of claim 15 further comprising GPS technology incorporated within or in electronic communication with the dive computer, said GPS technology provides a current underwater location of the diver.

18. The underwater electronic communication device of claim 15 further comprising a second receiver and a speaker located on a boat, wherein said second receiver receives dive information from the dive computer sent by the transmitter which is produced and heard through the speaker, wherein one or more occupants on the boat are informed of the dive information for the diver and can be alerted to any existing problem being experienced by the diver.

19. The underwater electronic communication device of claim 17 further comprising a second receiver and a speaker located on a boat, wherein said second receiver receives dive information from the dive computer sent by the transmitter which is produced and heard through the speaker, wherein one or more occupants on the boat are informed of the dive information for the diver and the diver's current underwater location and can be alerted to any existing problem being experienced by the diver.

20. The underwater electronic communication device of claim 17 wherein information concerning the current underwater location of the diver or an existing problem being experienced by the diver can be sent to a dive buddy for the diver and received by a receiver worn or associated with the dive buddy.
